(19) United States
(12) Patent Application Publication
(10) Pub. No.: US 2021/0187650 A1
(43) Pub. Date: Jun. 24, 2021

(54) STUD WELDING GUN

(71) Applicant: HILTI AKTIENGESELLSCHAFT, Schaan (LI)

(72) Inventors: Klaus BERTSCH, Frastanz (AT); Uwe POPP, Widnau (CH)

(21) Appl. No.: 16/757,527

(22) PCT Filed: Nov. 15, 2018
(86) PCT No.: PCT/EP2018/081300

§ 371 Date: Apr. 20, 2020

(30) Foreign Application Priority Data
Dec. 18, 2017 (EP) 17207946.9

(51) Int. Cl. B23K 9/20

(52) U.S. Cl. CPC B23K 9/202; B23K 9/205

(57) ABSTRACT

A fastening system for welding a welding stud in a welding direction to a substrate is provided, comprising a welding gun, which defines the welding direction, and the welding stud, wherein the welding gun has a holding device for holding the welding stud during a welding process and an outer contour, wherein the welding stud comprises a contact surface, which is provided for making contact with the substrate before and/or during the welding process, and wherein, starting from the contact surface, a tangent can be applied to the outer contour, which encloses an angle of less than 60° with the welding direction when the welding stud is held by the holding device and the contact surface is in contact with the substrate.

### TECHNICAL FIELD

In general terms, the invention relates to a fastening system for welding a welding stud to a substrate in a welding direction.

### PRIOR ART

There are numerous known devices and methods by which various studs are fastened to a substrate in different applications. For example, a stud is brought into contact with the substrate and an electric current is applied to it. For this purpose, the stud is held by an electrically conductive stud holder.

As soon as the electric current flows between the stud and the substrate, the stud is lifted off the substrate to form an arc. The energy that is released causes the material of the stud and the substrate to be partially liquefied. The electric current is then switched off and the stud is immersed in the liquefied material while this material cools down and becomes solid. The stud is then connected to the substrate in an integrally bonded manner.

In order to provide the necessary energy for liquefying the material of the stud and the substrate in a sufficiently short time, there are known devices that generate an electric current of a very high intensity and use a correspondingly rated electric cable to feed it to the stud. To avoid oxidizing of the liquefied material, it is known to surround the area of contact between the stud and the substrate with an inert gas.

In the case of applications in building construction or shipbuilding for example, threaded studs of various sizes to which an item is screwed are used in order to fasten the item to the substrate. Some parameters of the fastening method, such as for example the duration and electrical power of the electric current, are to be set by a user on the device and are to be adapted to the stud that is used. The user finally assesses the quality of the connection between the stud and the substrate by means of a visual inspection. The quality of the connection consequently also depends on the experience and capabilities of the user. While the stud is being placed against the substrate, the stud is not visible to the user.

### SUMMARY OF THE INVENTION

The object of the invention is to provide a device and/or a method with which fastening of a stud to a substrate is made easier and/or improved.

This object is achieved in the case of a fastening system for welding a welding stud in a welding direction to a substrate, comprising a welding gun, which defines the welding direction, and the welding stud, wherein the welding gun has a holding device for holding the welding stud during a welding process and an outer contour, wherein the welding stud comprises a contact surface, which is provided for making contact with the substrate before and/or during the welding process, and wherein, starting from the contact surface, a tangent can be applied to the outer contour, which encloses an angle of less than 60°, preferably less than 45°, particularly preferably less than 30°, with the welding direction when the welding stud is held by the holding device and the contact surface is in contact with the substrate. The welding gun preferably has a housing, which defines the outer contour or part of the outer contour.

An advantageous embodiment is characterized in that the welding gun has a holding spring, which acts on the holding device, and a bearing element having a bearing surface, and in that the holding device together with the welding stud can be moved relative to the bearing element counter to the welding direction, against a spring force of the holding spring, until the contact surface of the welding stud and the bearing surface are arranged at the same height in the welding direction.

An advantageous embodiment is characterized in that the welding gun has a contact pressure element having a contact pressure surface and a contact pressure spring, which acts on the contact pressure element, and wherein the contact pressure element can be moved relative to the bearing element counter to the welding direction, against a spring force of the contact pressure spring, until the contact surface of the welding stud and the contact pressure surface are arranged at the same height in the welding direction. The contact pressure surface, as viewed in the welding direction, is preferably arranged between the contact surface and the bearing surface.

Another aspect of the application is characterized in that the bearing element is substantially closed in a circumferential direction in relation to the welding direction and has a curved outlet channel. The outlet channel preferably has multiple curves.

### EXEMPLARY EMBODIMENTS

The invention will be explained in more detail below on the basis of exemplary embodiments with reference to the drawings. In the drawings:

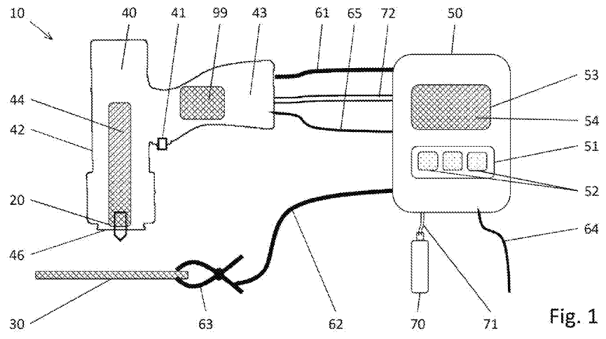

FIG. 1 schematically shows a welding device,

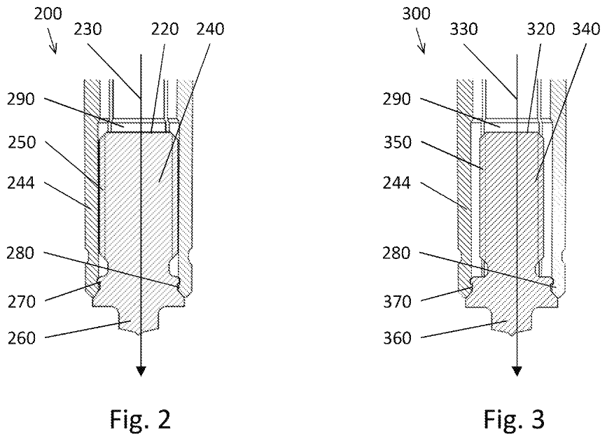

FIG. 2 shows a welding assembly in a partial longitudinal sectional view,

FIG. 3 shows a welding assembly in a partial longitudinal sectional view,

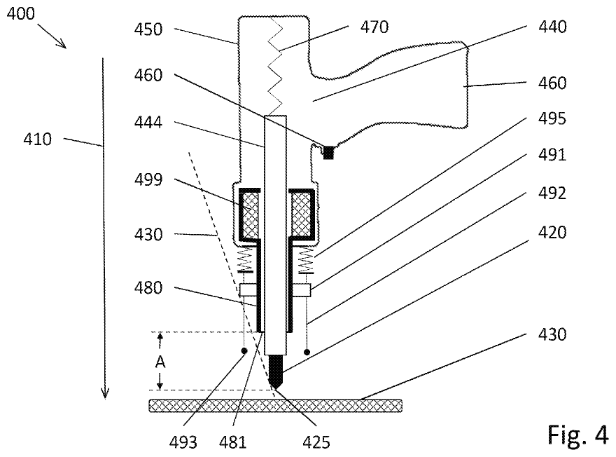

FIG. 4 shows a fastening system, and

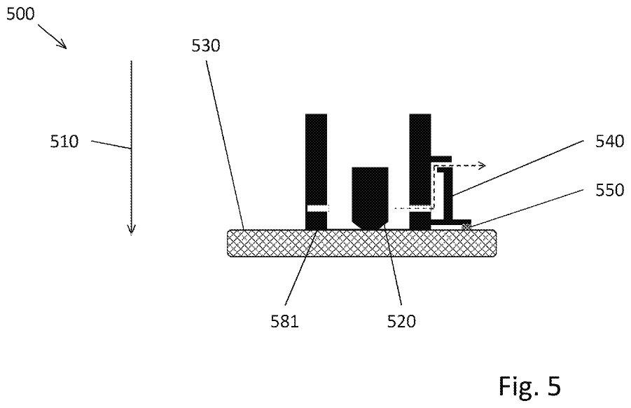

FIG. 5 shows a bearing element.

In FIG. 1, a welding device 10 for welding a welding stud 20 to a substrate 30 is schematically represented. A material of the welding stud 20 and a material of the substrate 30 are electrically conductive, in particular metallic. The welding device 10 comprises a welding gun 40 with a trigger switch 41, formed as a pushbutton switch, a welding unit 50, a first electric cable 61, a second electric cable 62 with a connection terminal 63, an electric supply cable 64, formed for example as a power cable, an electrical communication line 65, a gas reservoir 70, formed as a gas cylinder, a tubular gas supply line 71 and a gas hose 72.

The first cable 61 serves for supplying the welding stud 20 with electric current through the welding unit 50. The second cable 62 serves for electrically connecting the substrate 30 to the welding unit 50 when the connection terminal 63 is clamped to the substrate 30. When the welding stud 20 comes into contact with the substrate 30, a circuit closes, so that welding current, for example in the form of direct current or alternating current, can be applied to the welding stud 20 by the welding unit 50. For this purpose, the welding gun 40 comprises a welding-current contact element that is not shown in FIG. 1. The welding unit 50 comprises a device that is not shown for converting electric current from the supply cable 64 into welding current, which comprises for example an electrical capacitor, a thyristor, a bipolar transistor with an isolated gate electrode or other components from power electronics and also an associated control unit with a microprocessor, in order to provide the welding current at the desired voltage and current intensity.

The gas supply line 71 and the gas hose 72 serve for supplying a contact region between the welding stud 20 and the substrate 30 with an inert gas from the gas reservoir 70, in order to protect the contact region from oxidation due to oxygen from a surrounding area during a welding operation. For controlling a gas flow to the contact region, the gas reservoir 70, the gas supply line 71, the welding unit 50, the gas hose 72 or the welding gun 40 comprises a valve, in particular a controllable valve, that is not shown.

The welding unit 50 has an input device 51 with actuating elements 52 and also an output device 53 with a visual display element 54 and a wireless transmission unit. The input device 51 serves for inputting parameters of a welding method to be carried out with the welding device 10, such as for example the electrical voltage, current intensity, power and time duration of the welding current, position and speed of the stud and so on, by a user of the welding device 10. The output device 53 serves for outputting information to the user, such as for example information on parameters of the welding method, information on detected emissions of the welding method or other variables, information on a quality of the welding operation, information on measures for improving the welding operation, information on detected characteristics of the welding stud or information derived from the aforementioned variables, and/or recommendations or instructions for cleaning and/or maintaining the welding device 10, in particular the welding gun 40.

The communication line 65 serves for communication between the welding gun 40, in particular a control device of the welding gun 40 that is not shown in FIG. 1, and the welding unit 50, in particular the control unit and/or the input device 51 and/or the output device 53. By means of this communication, for example, an exchange of information about the parameters of a welding operation is accomplished, in order for example to achieve or facilitate a synchronization of the welding current with a movement of the welding stud 20. In the case of exemplary embodiments that are not shown, the communication between the welding gun and the welding unit takes place wirelessly, by radio or by means of the first electric cable, which carries the welding current.

The welding gun 40 has a housing 42 with an opening 46, from which housing a handle 43 with the trigger switch 41 protrudes. The welding gun 40 also has a stud holder 44, on which the welding stud 20 is held during a welding operation. For this purpose, the stud holder comprises for example two, three, four or more resilient arms that are not shown in detail, between which the welding stud 20 is inserted and held by means of a clamping fit. The welding gun 40 also has, for applying a welding current to the welding stud 20, a welding-current contact element which is integrated in the stud holder 44, for example in the form of one or more of the resilient arms.

The welding gun 40 also has a control device 99 for controlling the various components and devices of the welding gun and of the welding unit 50. The control device 99 is intended for controlling one or more parameters of the welding operation. For this purpose, the control device 99 comprises various electronic components, such as for example one or more microprocessors, one or more temporary or permanent data memories, and the like.

The welding gun 40 also has a stud lifting device, which is formed as a first lifting magnet, which acts on the stud holder 44 with a force away from the opening 46 to the rear (upwardly in FIG. 1) when the stud lifting device is activated. Via a signal line that is not shown, the control device 99 communicates with the stud lifting device in order to control the stud lifting device, in particular to activate and deactivate it.

The welding gun 40 also has a stud immersing device, formed as a spring element or as a second lifting magnet, which acts on the stud holder 44 forwardly with a force toward the opening 46 (downwardly in FIG. 1) when the stud immersing device is activated. Via a signal line that is not shown, the control device 99 communicates with the stud immersing device in order to control the stud immersing device, in particular to activate and deactivate it. If the stud immersing device takes the form of a spring element, this spring element is preferably tensioned when the stud holder is moved by the stud lifting device to the rear, with the result that the spring element moves the stud holder forward as soon as the stud lifting device is deactivated.

In a welding process with the welding apparatus 10, at first the substrate 30 and the stud 20 are provided. In a further step, information, for example about desired parameters of the following welding operation, are input by a user via the input device. In a further step, a welding current between the welding stud 20 and the substrate 30 is applied to the welding stud 20 by the welding unit 50 by means of the first cable 61 and the second cable 62. In a further step, the welding stud 20 is lifted off the substrate by means of the stud lifting device while maintaining the welding current flowing between the welding stud 20 and the substrate 30, with an arc being formed between the welding stud 20 and the substrate 30. Particularly on account of the heat generated by the arc, a material of the welding stud 20 and/or of the substrate 30 is then partially liquefied. In a further step, the welding stud 20 is immersed by means of the stud immersing device in the liquefied material of the welding stud 20 or of the substrate 30. The liquefied material of the welding stud 20 or of the substrate 30 then solidifies such that the welding stud 20 is connected to the substrate 30 in an integrally bonded manner.

FIG. 2 illustrates a welding assembly 200 with a welding stud 220 and a stud holder 244. The welding stud 220 has a shank 240, which defines a longitudinal direction 230 and which is provided with an attachment means 250 designed as an external thread, a welding region 260 at the end, which is provided for liquefaction during a welding process, and a holding means 270, which is designed as a depression, preferably a groove, running around in a circle, and which is arranged between the welding region 260 and the attachment means 250 in the longitudinal direction 230. The stud holder 244 has a holding device 280, which is designed as a projection which runs around in a circle and with which the holding means 270 is in engagement in order to hold the welding stud 220 during a welding process, e.g. using the welding device 10 (FIG. 1).

The stud holder 244 is part of a welding gun (not shown specifically) for welding the welding stud 220 to a substrate, which is of similar design to the welding gun 40 (FIG. 1), for example. The holding device 280 is arranged at a front end of the welding gun, with the result that the welding stud 220 is moved forward toward the substrate when the stud holder 244 is moved forward by a stud immersing device, for example. Behind the holding device 280, the welding gun, in particular the stud holder 244, has a socket 290, designed substantially as a cavity, for the attachment means 250 of the welding stud.

By means of this arrangement, on the one hand, the attachment means 250 is protected from damage by the holding device 280 and, on the other hand, it is ensured that the holding device 280 holds the welding stud in the desired position, irrespective of a length of the shank 240 thereof and/or of the attachment means 250. Moreover, it is possible to use a single stud holder for welding studs with different attachment means, in particular attachment means of different sizes.

FIG. 3 illustrates a second welding assembly 300 having a second welding stud 320 and the stud holder 244 from FIG. 2. The second welding stud 320 likewise has a shank 340, which defines a longitudinal direction 330 and which is provided with an attachment means 350 designed as an external thread, a welding region 360 at the end, which is provided for liquefaction during a welding process, and a second holding means 370, which is designed as a recess that runs around in a circle, is arranged between the welding region 360 and the attachment means 350 in the longitudinal direction 330 and has the same shape and the same dimensions as the holding means 270 of the welding stud 220 shown in FIG. 2.

The attachment means 350 of welding stud 320 has a smaller diameter than the attachment means 250 of welding stud 220 and is therefore likewise received in the socket 290 when welding stud 350 is held by the holding device 280 in engagement with the holding means 370. Welding stud 220 and the second welding stud 320 are thus part of a fastening system according to this application. Here, the welding region 260 of welding stud 220 is the same as the welding region 360 of the second welding stud 320 in shape and dimensions. This makes it possible to weld welding studs with different attachment means, in particular attachment means of different sizes, to the substrate using the same welding parameters, such as welding current intensity, electric voltage, welding current duration and the like.

FIG. 4 illustrates a fastening system 400 which is provided for welding a welding stud 420 to a substrate 430 in a welding direction 410. In addition to the welding stud 420, the fastening system 400 comprises a welding gun 440, which defines the welding direction 430 and has a housing 450 and a handle 460. The welding gun has a holding device 444, which is designed as a stud holder and which has a stud socket (not shown specifically) for holding the welding stud 420 during a welding process, into which the welding stud 420 can be inserted and is preferably held with a clamping action. A contact surface 425 of the welding stud 420 makes contact with the substrate 430 before and/or during the welding process. Starting from the contact surface 425, a tangent 460 can be applied to an outer contour of the welding gun 440, which encloses an angle of 20° with the welding direction 410. This enables a user of the fastening system 400 to clearly see the contact point of the welding stud 420 with the substrate 430, at least until the contact surface 425 makes contact with the substrate 430.

The welding gun 440 has a holding spring 470, which acts on the holding device 444 in the welding direction 410, and a bearing element 480 having a bearing surface 481 facing in the welding direction 410. The holding device 444 together with the welding stud 420 can be moved relative to the bearing element 480 counter to the welding direction 410, against a spring force of the holding spring 470, by a contact pressure travel A until the contact surface 425 of the welding stud 420 and the bearing surface 481 are arranged at the same height in the welding direction 410. The contact pressure travel A is the distance by which the welding gun 440 still has to be moved in the welding direction 410 from the time when the contact surface 425 makes contact with the substrate 430 before a welding process begins.

The welding gun has a contact pressure element 490, which has a guide ring 491 surrounding the bearing element 480, and two, three or more contact pressure arms 492, each having a contact pressure surface 493. The contact pressure arms 492 are connected rigidly to the guide ring 491, which can be moved in the welding direction 410 and, during this process, is guided by the bearing element 480. The welding gun furthermore has at least one contact pressure spring 495, in the example under consideration two such springs, which subject the contact pressure element 490, in the example under consideration the guide ring 491, to a spring force in the welding direction 410.

The contact pressure element 490 can be moved relative to the bearing element 480 against the welding direction 410, counter to the spring force of the contact pressure springs 495, until the contact surface 425 of the welding stud 420 and the contact pressure surfaces 493 are arranged at the same height in the welding direction 410. The contact pressure surfaces 493, as viewed in the welding direction 410, are arranged between the contact surface 425 and the bearing surface 481. This ensures that, during the placement of the fastening system 400 on the substrate 430, the contact surface 425 of the welding stud 420 makes contact with the substrate 430 first, followed by the contact pressure surfaces 493 of the contact pressure element 490 and finally by the bearing surface 481 of the bearing element 480. As soon as the bearing element 480 is resting on the substrate 430, a user can initiate a welding process by means of a triggering element 498.

The visibility of the welding stud 420 makes it easier for a user to place the contact surface 425 on the substrate 430 at the desired welding point or to correct the position of the contact surface 425 by means of the welding gun 440, in particular the handle 460 thereof. Since the user can see between the contact pressure arms 492, the tangent decisive for the viewing angle, can be applied to the bearing element 480 or, as in the example under consideration, to the guide ring 491, starting from the contact surface 425. As soon as the contact pressure surfaces 493 are resting on the substrate 430, the welding gun 440 is supported in the desired position, in particular against slipping. For this purpose, the contact pressure surfaces 493 are preferably composed of an elastomer.

The contact pressure springs 495 serve to reset the contact pressure element 490 after the welding gun 440 has been raised from the substrate 430, e.g. after a welding process. The holding spring 470 serves to reset the holding device 444 after the welding gun 440 has been raised from the substrate and/or during the welding process as an immersion device, which makes the welding stud previously moved away from the substrate by a lifting device 499 designed as a lifting magnet dip into a molten weld pool.

FIG. 5 illustrates a bearing element 500 with a bearing surface 581 for bearing on a substrate 530. The bearing element 500 is part of a welding gun (not shown further) for welding a welding stud 520 to the substrate 530 in a welding direction 510. The bearing element 500 is substantially closed in a circumferential direction in relation to the welding direction 510 and has an outlet channel 540, e.g. for a shielding gas flowing around the welding stud 520. FIG. 5 shows that the outlet channel 540 has two bends, thus reducing, in particular avoiding, a risk of escaping heat radiation or escaping hot material. The outlet channel 540 has a supporting foot 550 for support on the substrate 530, which comprises an elastomer or is composed of an elastomer, for example.

The invention has been described on the basis of examples of a system for fastening a first item to a second item and of a welding gun. In this case, the features of the described embodiments can also be combined as desired with one another within a single fastening device. It should be noted that the device according to the invention is also suitable for other purposes.

1. A fastening system for welding a welding stud to a substrate in a welding direction, the system comprising a welding gun, which defines the welding direction; and the welding stud, wherein the welding gun has a holding device for holding the welding stud during a welding process, and an outer contour; wherein the welding stud comprises a contact surface, which is provided for making contact with the substrate before and/or during a welding process, and wherein, starting from the contact surface, a tangent can be applied to the outer contour, which encloses an angle of less than 60° with the welding direction when the welding stud is held by the holding device and the contact surface is in contact with the substrate.

2. The fastening system as claimed in claim 1, wherein the tangent to the welding direction encloses an angle of less than 45°, when the welding stud is held by the holding device and the contact surface is in contact with the substrate.

3. The fastening system as claimed in claim 1, wherein the welding gun has a holding spring, which acts on the holding device; and a bearing element having a bearing surface, surface and wherein the holding device together with the welding stud can be moved relative to the bearing element counter to the welding direction, against a spring force of the holding spring, until the contact surface of the welding stud and the bearing surface are arranged at the same height in the welding direction.

4. The fastening system as claimed in claim 1, wherein the welding gun has a contact pressure element having a contact pressure surface and a contact pressure spring, which acts on the contact pressure element; as well as a bearing element having a bearing surface; wherein the contact pressure element can be moved relative to the bearing element counter to the welding direction, against a spring force of the contact pressure spring, until the contact surface of the welding stud and the contact pressure surface are arranged at the same height in the welding direction.

5. The fastening system as claimed in claim 3, wherein the contact pressure surface, as viewed in the welding direction, is arranged between the contact surface of the welding stud and the bearing surface.

6. The fastening system as claimed in claim 1 wherein the welding gun has a bearing element having a bearing surface, and wherein the bearing element is substantially closed in a circumferential direction in relation to the welding direction and has a curved outlet channel.

7. A welding gun comprising a holding device for holding the welding stud during a welding process and a bearing element having a bearing surface, wherein the bearing element is substantially closed in a circumferential direction in relation to a welding direction and has a curved outlet channel.

8. The fastening system as claimed in claim 2, wherein the tangent to the welding direction encloses an angle of less than 30°.

9. The fastening system as claimed in claim 6, wherein the curved outlet channel has multiple curves.

10. The fastening system as claimed in claim 2, wherein the welding gun has a holding spring, which acts on the holding device; and a bearing element having a bearing surface; and wherein the holding device together with the welding stud can be moved relative to the bearing element counter to the welding direction, against a spring force of the holding spring, until the contact surface of the welding stud and the bearing surface are arranged at the same height in the welding direction.

11. The fastening system as claimed in claim 2, wherein the welding gun has a contact pressure element having a contact pressure surface and a contact pressure spring, which acts on the contact pressure element; as well as a bearing element having a bearing surface; and wherein the contact pressure element can be moved relative to the bearing element counter to the welding direction, against a spring force of the contact pressure spring, until the contact surface of the welding stud and the contact pressure surface are arranged at the same height in the welding direction.

12. The fastening system as claimed in claim 3, wherein the welding gun has a contact pressure element having a contact pressure surface and a contact pressure spring, which acts on the contact pressure element; as well as a bearing element having a bearing surface; and wherein the contact pressure element can be moved relative to the bearing element counter to the welding direction, against a spring force of the contact pressure spring, until the contact surface of the welding stud and the contact pressure surface are arranged at the same height in the welding direction.

13. The fastening system as claimed in claim 4, wherein the contact pressure surface, as viewed in the welding direction, is arranged between the contact surface of the welding stud and the bearing surface.

14. The fastening system as claimed in claim 2, wherein the welding gun has a bearing element having a bearing surface, and wherein the bearing element is substantially closed in a circumferential direction in relation to the welding direction and has a curved outlet channel.

15. The fastening system as claimed in claim 3, wherein the welding gun has a bearing element having a bearing surface, and wherein the bearing element is substantially closed in a circumferential direction in relation to the welding direction and has a curved outlet channel.

16. The fastening system as claimed in claim 4, wherein the welding gun has a bearing element having a bearing surface, and wherein the bearing element is substantially closed in a circumferential direction in relation to the welding direction and has a curved outlet channel.

17. The fastening system as claimed in claim 5, wherein the welding gun has a bearing element having a bearing surface, and wherein the bearing element is substantially closed in a circumferential direction in relation to the welding direction and has a curved outlet channel.

18. The fastening system as claimed in claim 10, wherein the welding gun has a contact pressure element having a contact pressure surface and a contact pressure spring, which acts on the contact pressure element; as well as a bearing element having a bearing surface; and wherein the contact pressure element can be moved relative to the bearing element counter to the welding direction, against a spring force of the contact pressure spring, until the contact surface of the welding stud and the contact pressure surface are arranged at the same height in the welding direction.

19. The fastening system as claimed in claim 10, wherein the contact pressure surface, as viewed in the welding direction, is arranged between the contact surface of the welding stud and the bearing surface.

20. The welding gun according to claim 7, wherein the curved outlet channel has multiple curves.
